(19) United States
(12) Patent Application Publication
(10) Pub. No.: US 2007/0176769 A1
(43) Pub. Date: Aug. 2, 2007

(54) Warning system for people in hazardous conditions

(76) Inventor: Jurgen Boss, Berlin (DE)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/550,467

(22) PCT Filed: Feb. 26, 2004
(86) PCT No.: PCT/DE04/00378

§ 371 Date: Jul. 17, 2006

(30) Foreign Application Priority Data
Mar. 24, 2003 (DE) 103-14-135.9

(51) Int. Cl. G08B 1/08; G08B 23/00

(52) U.S. Cl. 340/539.11; 340/573.1

(57) ABSTRACT

A warning system for people working in hazardous conditions consisting of a control unit with a motion detector, a memory for recording incidents. a display. and an alarm transmitter. The control unit is equipped with a receiver and designed as a standalone base warning unit and. based on a use- or cost-oriented approach is optionally connectable via a physical link to a data transmitter and/or a walkie-talkie and/or via a radio connection to a radio pressure gauge for a compressed-air breathing apparatus and/or a radio measuring device for detecting gas and temperature conditions.

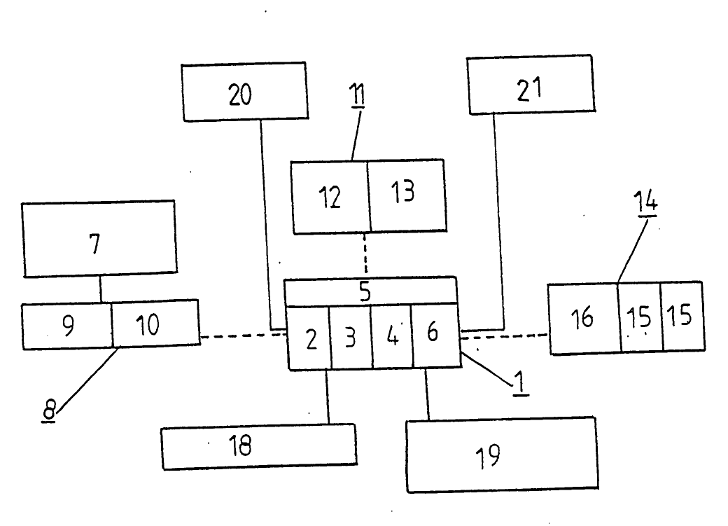

The invention relates to a warning system for people working in hazardous conditions.

When working under hazardous conditions such as on a fire-fighting or similar rescue mission, it is common and required that rescue workers, mostly carrying a compressed-air breathing apparatus, be equipped with suitable warning devices that indicate a health hazard or life-threatening condition to protect their lives.

A warning device of this kind known from DE 199 36 893 is connected to a compressed-air cylinder to measure the pressure in the cylinder with a sensor integrated in the warning device or to calculate the quantity of compressed air or the remaining time a rescuer can go on working from the current pressure and the pressure drop per time unit. The device also includes a temperature sensor to measure the outside temperature and a motion sensor for detecting user immobility. The limits referring to the compressed-air supply or temperature are displayed and an alarm is triggered if temperature or pressure limits are exceeded or if the wearer does not move. A telemetry system integrated in the device transmits the measured data to a master station where it is analyzed and stored while the master station can use the telemetry system to influence the warning device such as change alarm thresholds, trigger alarms, or communicate with the wearer of the device. This warning device, however, has setbacks as its use for most of its functions requires connection to a compressed-air cylinder but it is frequently undesirable, unnecessary, or impossible for budget reasons or the specifics of the respective application to purchase and use an expensive device.

The monitoring and warning system for fire and disaster rescue personnel described in DE 101 20 775 A1 comprises a base unit with a microcomputer, a measured value and alarm display, an alarm transmitter and a motion detector. The base unit and a telemetry system are connected to a system assigned to each rescuer, such as a bus system integrated in the protective clothing. Multiple other monitoring, communication, or control modules can selectively and replaceably coupled with the bus or coupled via an optical or radio connection to the basic equipment consisting of a base unit, bus, and telemetry module. Although this monitoring and warning system can be customized by adding or replacing modules, it is relatively sophisticated because of its coupling to a bus system and cannot be justified for use in any working conditions.

It is the object of the invention to provide a warning system for people working in hazardous conditions that has a wide range of uses due to a simple and cost-efficient base unit that can be extended at low cost, if required, to suit a particular use.

This problem is solved according to the invention by the warning system comprising the characteristics described in claim 1. The dependent claims disclose further characteristics and advantageous embodiments of the invention.

The concept of the invention is, in other words, to provide a pocket-sized control unit that is simple, lightweight, space-saving, and cost-efficient, that in itself meets the safety requirements for some applications such as fire-fighting, and is independent of other pieces of equipment such as a compressed-air breathing apparatus or electric cabling. The uses are manifold for the reasons stated above. As the pocket-sized control unit can be equipped with a receiver, display, and memory, it can optionally—and as the budget may allow or its use may require—be supplemented with a radio pressure gauge connected to a compressed-air breathing apparatus and/or a vital functions radio monitor and/or a radio measuring device for recording temperature, gas composition and the like to become a comprehensive and convenient warning system that can be further completed by adding a data transmitter and/or walkie-talkie. This means that a cost-efficient warning device for each use, for fire-fighting or rescue missions as well as for skiers, hikers, mountaineers, alpine rescue services and the like is provided that in itself is sufficient for most uses and therefore low-cost but can easily be extended if required and if the respective funds are available.

An embodiment of the invention will now be explained in more detail and with reference to a block diagram of a warning system.

The core of the warning system is a base unit called pocket-sized control unit 1 due to its advantageous space-saving design. This simple and lightweight base warning device that can be carried along in a person's pocket and is independent of a compressed-air breathing apparatus or bus system can be used, for example, by extreme athletes, security personnel, in military operations and many other applications. It comprises a motion sensor 2 with alarm transmitter 3, a receiver 4 with display 5, and a memory 6 for recording incidents. The simple control unit 1 that of course comprises controls and an integrated power supply (not shown) with its motion sensor and alarm transmitter, receiver and display for data communication provides in itself a sufficient safety level for many applications; at the same time, its alarm transmitter and receiver provide extension options of the warning system initially just made up of the control unit 1 for other applications with higher safety requirements.

As the figure shows, a radio pressure gauge 8, i.e. a digital pressure sensor 10 combined with a short-distance transmitter 9, can be connected to control units carried by people equipped with a compressed-air breathing apparatus 7. The pressure data transmitted by the radio pressure gauge 8 are received by the receiver 4 of the control unit 1 and displayed on the display 5. If the pressure rises above or drops below specific pressure parameters of the compressed-air breathing apparatus 7, the alarm transmitter 3 of the control unit 1 triggers an alarm.

Depending on the type of use and existing safety requirements, the pocket-sized control unit 1 can be supplemented, in addition to or instead of the radio pressure gauge 8, with a vital functions monitor 11 which is a combination of a vital sensor 13 with the short-distance transmitter 12 to collect vital data of the respective wearer.

Another option for an additional or alternative extension of the pocket-sized control unit 1 is the use of a radio measuring device 14 communicating with the control unit 1, a combination of at least one gas/temperature sensor 15 that measures environmental conditions (gas composition, temperature) with a short-distance transmitter 16. If such a radio measuring device 14 is carried along by rescue personnel, the receiver 4 of the control unit 1 receives the environmental data measured and transmitted by the radio measuring device 14, and this data is displayed on the display 5 of the control unit 1 and stored in the memory 6 and can trigger an alarm of the alarm transmitter 3 if values rise above or drop below certain limits.

In addition, the warning system includes another separate additional radio data transmitter 18 connected to the control unit 1 via a physical link 17 for transmitting the data received by control unit 1 and stored in its memory 6 such as immobility and cylinder pressure and/or temperature and gas composition data to a master station and/or data-capable walkie-talkie for voice communication with another control unit and/or the master station. Additionally or alternatively, a separate camera 20 and/or thermal image camera 21 can be connected.

### LIST OF REFERENCE SYMBOLS

1 Pocket-sized control unit

2 Motion detector

3 Alarm transmitter

4 Receiver

5 Display

6 Memory

7 Compressed-air breathing apparatus

8 Radio pressure gauge

9 Short-distance transmitter

10 Digital pressure sensor

11 Vital functions radio monitor

12 Short-distance transmitter

13 Vital sensor

14 Radio measuring device

15 Gas/temperature sensor

16 Short-distance transmitter

17 Physical link

18 Data transmitter

19 Walkie-talkie

20 Camera

21 Thermal image camera

1. (canceled)

2. The warning system according to claim 6, wherein the radio pressure gauge is a pressure sensor with a short-distance transmitter connected to a compressed-air cylinder.

3. The warning system according to claim 6, wherein the vital function radio monitor includes at least a vital sensor combined with a short-distance transmitter for collecting the user's vital data.

4. The warning system according to claim 6, wherein the radio measuring device includes a gas or temperature sensor coupled with a short-distance transmitter.

5. The warning system according to claim 6, wherein a camera and/or thermal image camera can be coupled with the control unit.

6. A warning system for people working in hazardous conditions, the warning system comprising: a control unit with a motion detector, a memory for recording incidents, a display, and an alarm transmitter, the control unit being equipped with a receiver and designed as a standalone case warning unit and, based on a use- or cost-oriented approach, being optionally connectable via a physical link to a data transmitter, and/or a walkie-talkie and/or via a radio connection to a radio pressure gauge for a compressed-air breathing apparatus and/or a radio measuring device for detecting gas and temperature conditions.
